(19) United States
(12) Patent Application Publication
(10) Pub. No.: US 2005/0211558 A1
(43) Pub. Date: Sep. 29, 2005

(54) Capillary and electrophoresis apparatus

(75) Inventors: Tsuyoshi Sonehara, Kokubunji (JP); Takashi Anazawa, Kodaira (JP); Tomoyuki Sakai, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi High-Technologies Corporation.

(21) Appl. No.: 11/006,535

(22) Filed: Dec. 8, 2004

(30) Foreign Application Priority Data
Mar. 25, 2004 (JP) 2004-088305

(51) Int. Cl. G01N 27/453

(52) U.S. Cl. 204/601; 204/603

(57) ABSTRACT

An end detection type capillary electrophoresis apparatus that enables high-speed electrophoresis at a high resolution. The capillary electrophoresis apparatus has an inner diameter of at least 20 μm and less than 80 μm, and satisfies the constraint that the inner diameter/glass outer diameter≧0.34. High fluorescence detection sensitivity is maintained and an analysis is carried out more quickly even as separation power improves.

### CLAIM OF PRIORITY

The present application claims the benefit under 35 U.S.C. § 119 of the earlier filing date of Japanese Patent Application JP 2004-088305 which was filed on Mar. 25, 2004, the content of which is hereby incorporated by reference into the present application.

### BACKGROUND OF THE INVENTION

1. Field of the Invention

The present invention relates to a capillary and electrophoresis apparatus that separates a sample, such as fluorescently labeled DNA, RNA or protein, by means of electrophoresis, detects fluorescence pumped by a laser, and then analyzes the sample, including a base sequence and base length of the DNA.

2. Description of the Background

The present invention utilizes what is generally known as an electrophoresis apparatus. An electrophoresis apparatus separates a sample, such as fluorescently labeled DNA, by means of electrophoresis with respect to molecular weight, irradiates the sample with a laser beam, detects the fluorescence emitted from the fluorescently labeled DNA, and then analyzes a series of detected signals.

Various fluorescence detection methods are currently in use. In JP-A No. 96623/1997 (hereafter “Patent document 1”), the DNA that migrates electrophoretically in a capillary is irradiated with a laser beam, and the fluorescence emitted from the DNA is detected from a direction orthogonal to the migration direction of the sample. In this application, the fluorescence detection method in which the sample is detected from the direction orthogonal to the migration direction of the sample in this manner is called “orthogonal detection.”

On the other hand, in JP-A No. 261988/1996 (“Patent document 2”), DNA that migrates electrophoretically in a migration plate is irradiated with a laser beam, and the fluorescence emitted from the DNA is detected from the direction in which the DNA migrates. Similarly, in Electrophoresis 2000, vol. 21, pp. 3,290 to 3,304 (“Non-patent document 1”), WO 00/04371 (Japanese Domestic Announcement No. 520616/2002, “Patent document 3”), and JP-A No. 19846/1998 (“Patent document 4”), DNA that migrates electrophoretically in a capillary is irradiated with a laser beam, and the fluorescence emitted from the DNA is detected from the direction in which the DNA migrates. In Non-patent document 1 and Patent documents 3 and 4, the fluorescence is transmitted to a capillary end using the capillary itself as a waveguide, and the fluorescence emitted from the capillary end is detected through a liquid tank. This fluorescence detection method is referred to as “end detection” herein.

The fluorescence transmission in end detection is based on the total internal reflection phenomena in a capillary. On the other hand, in DNA sequencing by means of capillary electrophoresis (“CE”), a silica glass capillary with a refractive index of 1.46 coated with a polymer is used, and the inner diameter of the capillary is filled with a DNA separation matrix whose refractive index is about 1.4 (i.e., 1.36 to 1.42). In this case, because the refractive index of the glass is higher than the refractive index of the matrix in the inner diameter, the fluorescence emitted from inside the inner diameter is not completely reflected at the interface between the inner diameter and glass. Accordingly, in order to apply the end detection to the DNA sequencing, the fluorescence must be completely reflected at the interface between the polymer and glass. For that purpose, a capillary coated with a polymer whose refractive index is lower than 1.4 must be used.

Such capillaries are supplied, for example, from Polymicro Technology LLC as standard products of type number TSU100375 or TSU075375. These capillaries are coated in both cases with a fluorine polymer whose refractive index is 1.31. The inner diameter including a coating is 375 μm, and the thickness of the coating is 15 μm. Accordingly, the glass inner diameter is 375−15×2=345 μm. Moreover, the inner diameter of the TSU1000375 and the inner diameter of TSU075375 are 100 μm and 75 μm, respectively. In Non-patent document 1 and Patent document 3, the TSU100375 with an inner diameter of 100 μm is used.

End detection allows luminous points to be arranged two-dimensionally regardless of a capillary arrangement at an excitation beam irradiation point, and is suitable for the integration of multiple carriers. In Non-patent document 1, 91 capillaries of the TSU100375 type are integrated, and the simultaneous sequencing of 91 DNA samples is successfully carried out.

Additionally relevant, it is described in Analytical Chemistry 1998, vol. 70, pp. 3,996 to 4,003 (“Non-patent document 2”) and Electrophoresis 2001, vol. 22, pp. 629 to 643 (“Non-patent document 3”) that a capillary whose inner diameter is less than 80 μm has excellent resolving power.

### SUMMARY OF THE INVENTION

In Non-patent document 1, a capillary with an inner diameter of 100 μm is used at an electric field strength of 100 V/cm. As a result, the mean migration time of 154 bases is obtained in 38 minutes, and a maximum read length of 430 bases is obtained. However, in the large-scale DNA analyses used recently, a higher speed and higher resolution analysis is required together with an increase in the size of the number of samples that can be simultaneously processed. Neither the migration time nor the maximum read length of the current devices is satisfactory. Moreover, in end detection, because fluorescence must be detected from the inner diameter of the capillary, excellent sensitivity must be carefully sustained without lowering the light collection efficiency.

Prior to the detailed description, the theory of the inner diameter/outer diameter ratio and sensibility of a capillary will now be described. As long as the Joule heat effect can be neglected, as the electric field strength becomes higher, separation power improves and analysis time is shortened. That is, even a long base length can be read in a shorter time. Therefore, in the latest CE-based DNA sequencing, an electric field strength of at least 150 V/cm, which is higher than the 100 V/cm of Non-patent document 1, is typically used. At the same time, the inner diameter of the capillary is reduced to prevent the lowering of electrophoretic separation power caused by an increase in the Joule heat.

In more detail, when a system according to Non-patent document 1 is made for a practical application, the inner diameter must be changed to less than 80 μm in order to prevent the lowering of the electrophoretic separation power caused by an increase in the Joule heat. This change is possible if the TSU075375 is used instead of the TSU100375. However, in end detection, when the outer diameter of the glass is sustained and only the inner diameter is reduced, then the light collection efficiency of fluorescence is reduced and the sensibility lowers. Therefore, in order to maintain the sensitivity and reduce the inner diameter, the glass outer diameter must be reduced at the same time.

FIG. 1 shows the basic composition of a capillary electrophoresis apparatus using end detection. The excitation light radiated from a laser 2 is collected in a capillary 1 by an irradiation lens 3. The fluorescence pumped in the capillary 1 is transmitted to an end face by means of total internal reflection. The fluorescence radiated from the end face changes into a collimated beam through a liquid tank 4 by a collection lens 6. After the light other than the fluorescence is intercepted by a filter 7, an image is formed on a photoelectric surface of a CCD camera 9 by an imaging lens 8. A voltage is applied between the liquid tank 4 and a liquid tank 5 by a high-voltage power supply 26, and an analyte molecule migrates electrophoretically in the capillary.

FIG. 2 is an enlarged capillary cross section diagram. A silica glass capillary allows the inner diameter to be filled with a DNA separation matrix, and the circumference to be coated with a polymer. In this application, as shown in FIG. 2, the inner diameter is represented by D₁, the outer diameter of the silica glass is represented by D₂, and the outermost diameter including a coating is represented by D₃.

FIG. 3 is an enlarged capillary end diagram of the end of the capillary at which fluorescence is detected. FIG. 2 shows the ray transmission path in end detection. Since the capillary center axis and the optical axis of the collection lens match in the vicinity of the capillary end, both the axes are merely called the optical axis herein. In a laser beam irradiation point, two fluorescence rays (Ray 1 and Ray 2 in FIG. 2) radiated at the same angle θ in respect to the optical axis are depicted. As shown in the figure, in the end detection, the fluorescence propagates in both the inner diameter and a glass part, and is radiated from both these parts even in an end. Ray 1 corresponds to a case in which the fluorescence is radiated from the inner diameter at the end, and Ray 2 corresponds to a case in which the fluorescence is radiated from the glass part at the end.

When Ray 1 and Ray 2 are radiated from the capillary end, and the bottom face of the liquid tank 4 transmits both the rays, then both the rays appear in the air at angles made with the optical axis specified as φ1 and φ2, respectively. Since the angle made with the optical axis when Rays 1 and 2 enter the glass is common, this angle is specified as θ_{g}. Because the refractive index (≈1.4) of the DNA separation matrix in the inner diameter is less than the glass refractive index (1.46), both the rays are refracted so as to satisfy θ<θ_{g}. As seen in Ray 1, when the ray returns into the inner diameter and comes out from the capillary end, the angle made by the ray with the optical axis returns to θ by means of repeated refraction. On the other hand, as seen in Ray 2, when the ray enters the glass and comes out from the end face, little refraction occurs, and the angle made by the ray with the optical axis is sustained at almost θ_{g}.

As a result, even when the ray finally comes out in the air, φ1<φ2. In an excitation point, a ray radiated at the same angle θ with respect to an optical axis is collected by a light collection lens when the ray is radiated from the inner diameter, but is not collected when the ray is radiated from the glass part. That is, the light collection efficiency of end detection with respect to the ray radiated from the glass part decreases in comparison with that of the ray radiated from the inner diameter. Further, the light collection efficiency of the end detection with respect to the ray radiated from the inner diameter is substantially equal to the light collection efficiency of conventional orthogonal detection.

In order to quantitatively discuss the above problem, it is assumed in the composition of FIG. 1 that the fluorescence of total power=1 is radiated isotropically in the excitation point, and the filter 7 transmits 100% of the fluorescence radiated from an end face and caught by the light collection lens 6. Therefore, a fluorescence image of a capillary end face is formed on the photoelectric surface of the CCD camera 9 at magnification=1. Furthermore, on a CCD, an electric charge is binned in a circular area having diameter d that is concentric with an end face image. At this time, the quantity S of the fluorescence detected by the CCD camera is represented by equation (1), with the constraints of equation (2):

$$\begin{matrix}S ( d ) = \{ \begin{matrix}\frac{d}{{D}_{1}} {\int }_{0}^{{θ}_{1}} \frac{R}{R + ( 1 - R ) tan θ / tan φ} \frac{sin θ}{2} ⅆ θ ( 0 \leq d < {D}_{1} ) \\ {\int }_{0}^{{θ}_{1}} \frac{R}{R + ( 1 - R ) tan θ / tan φ} \frac{sin θ}{2} ⅆ θ + \frac{d - {D}_{1}}{{D}_{2} - {D}_{1}} \\ {\int }_{0}^{{θ}_{2}} \frac{1 - R}{1 - R + R tan φ / tan θ} \frac{sin θ}{2} ⅆ θ ( {D}_{1} \leq d < {D}_{2} )\end{matrix} \\ R ≡ \frac{{D}_{1}}{{D}_{2}} , \\ φ ≡ arccos ( \frac{{n}_{p}}{{n}_{g}} cos θ ) , \\ {θ}_{1} = min ( arcsin ( \frac{1}{2 {n}_{p} F} ) , arccos ( \frac{{n}_{c}}{{n}_{p}} ) ) & ( 1 ) \\ {θ}_{2} = \{ \begin{matrix}0 & ( 1 + \frac{1}{{( 2 {n}_{p} F )}^{2}} - {( \frac{{n}_{g}}{{n}_{p}} )}^{2} < 0 ) \\ min ( arcsin \sqrt{1 + \frac{1}{{( 2 {n}_{p} F )}^{2}} - {( \frac{{n}_{g}}{{n}_{p}} )}^{2}} , & ( 1 + \frac{1}{{( 2 {n}_{p} F )}^{2}} - {( \frac{{n}_{g}}{{n}_{p}} )}^{2} \geq 0 ) \\ arccos ( \frac{{n}_{c}}{{n}_{p}} ) ) & \end{matrix} & ( 2 )\end{matrix}$$

where n_{g} is the refractive index of silica glass (RI=1.46), nₚ is the refractive index of a DNA separation matrix (RI≈1.4; e.g., in the range of 1.36-1.42), n_{c} is the refractive index of a capillary coating (RI=1.31), and F is an f-number of the collection lens.

FIG. 4 is a plot of S with respect to d in the same collection lens (F=0.95) as used in Non-patent document 1. In general, the S plot appears as a folded, kinked line about d=D₁, the slope of which is defined by equation (3):

$${m}_{1} = \frac{1}{{D}_{1}} {\int }_{0}^{{θ}_{1}} \frac{R}{R + ( 1 - R ) tan θ / tan φ} \frac{sin θ}{2} ⅆ θ \\ {m}_{2} = \frac{1}{{D}_{1}} {\int }_{0}^{{θ}_{2}} \frac{R}{1 - R + R tan φ / tan θ} \frac{sin θ}{2} ⅆ θ \qquad ( 3 )$$

Ordinarily, m₁>m₂ corresponding to a low light collection efficiency from the glass part. On the other hand, when the DNA concentration is diluted, CCD noise is the function of a diameter d of a binning area, and is represented by equation (4):

$$N ( d ) = \sqrt{\frac{π {d}^{2} {i}_{d} T}{4} + {Nr}^{2}} \qquad ( 4 )$$

where i_{d} is the CCD dark current per unit area, T is the sampling interval, and Nr is the readout noise. When the cooling CCD 701x series manufactured by Hamamatsu Photonics is cooled at 0 degrees Centigrade and in a sampling interval of one second (as are typical conditions in a DNA sequencer), FIG. 8 shows the relationship between N (noise) and d (with i_{d}T=0.0347 electron/mm² and Nr=8 electrons). Generally, N increases monotonically with respect to d, and increases linearly when d is fully large.

FIG. 6 shows the relationship between a S/N (signal-to-noise ratio) and d obtained with reference to FIG. 4 and FIG. 5. FIG. 6 shows the case in which D₁=100. Generally, the S/N is maximized when d=D₁. That is, in end detection, it is acceptable that a binning area should be almost equal to the inner diameter. However, when the binning area is extended to include the fluorescence radiated from the glass part of an end face, the S/N will lower. In other words, the end detection is useless if the fluorescence radiated from the glass part is detected.

In order to improve sensitivity, the quantity of fluorescence radiated from the inner diameter must increase. If the glass outer diameter is sustained on the same level and the inner diameter is reduced, the ratio at which the fluorescence is radiated from the glass part increases and the ratio at which the fluorescence is radiated from the inner diameter decreases. This is the reason why the glass outer diameter must also decrease at the same time as the inner diameter decreases.

On the other hand, as described above, the light collection efficiency of end detection is the same as for orthogonal detection with respect to the fluorescence radiated from the inner diameter. Accordingly, when the ratio at which the fluorescence is radiated from the inner diameter on an end face is 100%, the total light collection efficiency becomes equal in the end detection and orthogonal detection. Since the glass part cannot actually be eliminated, the ratio at which the fluorescence is radiated from the glass part cannot be set to 0%. That is, the light collection efficiency of the end detection is slightly inferior to that of the orthogonal detection ordinarily.

In Non-patent document 1, the DNA sequencing is successful. However, a person skilled in the art considers it to be common that the user of a DNA sequencer of a conventional orthogonal detection method cannot allow any additional lowering of the light collection efficiency and sensitivity. Accordingly, conditions under which the inner diameter is set to less than 80 μm and the light collection efficiency and sensitivity are maintained equal to or beyond that in Non-patent document 1 are examined in detail.

A first composition according to the present invention will now be described. As detailed above, only the fluorescence radiated from the inner diameter and detected in end detection is valuable, and this quantity represents the light collection efficiency of the end detection. This quantity of light is obtained from equation (1) as S when the diameter of a binning area is d=D₁, and appears as:

$${S}_{0} ≡ {S}_{d = {D}_{1}} = {\int }_{0}^{{θ}_{1}} \frac{R}{R + ( 1 - R ) tan θ / tan φ} \frac{sin θ}{2} ⅆ θ \qquad ( 5 )$$

FIG. 7 shows the relationship between S₀ and D₁/D₂ in each of F=0.95, F=1.1 and F=1.2. A combination of F=0.95 and D₁/D₂=0.29 corresponds to Non-patent document 1 and Patent document 3.

On the other hand, a lens such as F<1 usually includes the disadvantages of being large in aberration, short in focal length and working distance, and narrow in a field of view. In Non-patent document 1, the crosstalk of 0.4% between capillaries is realized using a lens of F=0.95 and a focal length of 25 mm. However, in consideration of medical applications, the crosstalk of a DNA sequencer should preferably be lower. For this purpose, a low aberration camera lens with a focal length of at least 50 mm is preferred. Typically, such a lens is F<1, and F=1.1 or 1.2 constitutes a practical limit. As shown in FIG. 7, when such a lens is used, a condition under which S0 that is equal to Non-patent document 1 (F=0.95 and D₁/D₂=0.29) or more is D₁/D₂≧0.34. In particular, an easy-to-manufacture industrially and low-cost F≧1.2 lens is used, D₁/D₂≧0.43 is necessary.

At this point, because the inner diameter of less than 20 μm is easily clogged and hard to irradiate with a laser beam, the inner diameter must be set to at least 20 μm. Moreover, in order to improve the separation power using a high electric field, and to prevent the lowering of electrophoretical separation power caused by an increase in the Joule heat, the inner diameter must be set to less than 80 μm.

In conventional orthogonal detection, as the f-number (F) of the collection lens is reduced, the light collection efficiency improves. However, in end detection, a ray in which the angle made with an optical axis is higher than a value determined by the refractive index nₚ of a DNA separation matrix and the refractive index n_{c} of a capillary coating is not completely reflected and transmitted. As a result, even if the F is made lower than the value determined by nₚ and n_{c}, the light collection efficiency will not increase. Even if the light collection efficiency does not increase, as a bright lens whose F is low, a cost increase occurs. That is, when the F is made lower than a predetermined value, an entirely wasteful cost is introduced. The condition under which this wasteful cost is prevented is assigned by equation (6):

$$\frac{0.5}{\sqrt{{n}_{p}^{2} - {n}_{c}^{2}}} \leq F \qquad ( 6 )$$

In Non-patent document 1, because nₚ=1.4, n_{c}=1.31, and F=0.95, equation (6) is satisfied and a cost occurs. When a lens of F≧1.0, for example, F=1.1 or F=1.2 or F=1.4 is used, this cost can be eliminated. Otherwise, this cost is prevented by using AF2400 (Du Pont) of n_{c}=1.29 as a coating, for example.

In sum, the first composition of the present invention is characterized by 20 μm≦D₁≦80 μm for D₁/D₂≧0.34.

A second capillary composition example will now be described. In this second example, the radiant quantity of fluorescence in a beam irradiation point and the effect of a CCD noise are included in the calculation, and the condition under which the S/N that is equal to or beyond that of Non-patent document 1 is examined. When a beam narrows down satisfactorily, the light emission quantity of the fluorescence is proportional to the inner diameter. The CCD noise is the same as for FIG. 5.

FIG. 8 shows the relationship between the glass outer diameter and the S/N when the inner diameter is 50, 75, or 100 μm, respectively. As shown in FIG. 8, in order to obtain the same S/N when the inner diameter of Non-patent document 1 is 100 μm and the glass outer diameter is 345 μm, it proves that the glass outer diameter must be set to less than 128 μm and 247 μm when the inner diameter is 50 μm and 75 μm, respectively.

FIG. 9 shows the relationship between the inner diameter of less than 80 μm and the upper limit of the glass outer diameter in which the S/N that is equal to or beyond that in Non-patent document 1 can be sustained. When the inner diameter is less than 20 μm, the glass outer diameter must be made shorter than the inner diameter. Consequently, no capillary can be found. The curve of FIG. 9 approximates almost perfectly when D₂=−0.000328D₁³+0.0604D₁²+0.716D₁−15 within the range of 20≦D₁≦80. Accordingly, a condition under which the same S/N is obtained and excellent electrophoresis performance can be sustained is 20≦D₁≦80, and D2≦−0.000328D₁³+0.604D₁²+0.716D₁−15 can be represented.

In the composition of end detection, fluorescence detection sensitivity is sustained and the inner diameter may be reduced. The use of a high electric field is enabled by reducing the inner diameter, and an analysis can be made more quickly with an improvement in separation power.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a conceptual illustration of end detection;

FIG. 2 is a cross-section diagram through a plane orthogonal to the center axis of a capillary;

FIG. 3 is a cross-section diagram showing the plane including the center axis of the capillary and a transmission path of fluorescence;

FIG. 4 shows the relationship between a diameter d of a binning area on a CCD and the quantity S of the detected fluorescence;

FIG. 5 shows the relationship between the diameter d of the binning area on the CCD and the noise N;

FIG. 6 shows the relationship between the diameter d of the binning area on the CCD and the S/N;

FIG. 7 shows the relationship between light collection efficiency S₀ and the ratio D₁/D₂ of the outer diameter to the inner diameter of glass when a collection lens is F=0.95, F=1.1 and F=1.2, respectively;

FIG. 8 shows the relationship between the S/N and the outer diameter D₂ when the inner diameter D₁ is 50, 75, and 100, respectively;

FIG. 9 is the S/N-sustainable outer diameter D₂ with respect to the inner diameter D1 of less than 80

FIG. 10 shows a cross-section diagram of the capillary and a required specification in a first embodiment;

FIG. 11 shows the composition of a second embodiment;

FIG. 12 shows a cross-section diagram of the capillary and the required specification in the second embodiment;

FIG. 13 shows a sequence electropherogram obtained pursuant to the second embodiment;

FIG. 14 shows an alternate beam irradiation method in the second embodiment; and

FIG. 15 shows a cross-section diagram of the capillary and the required specification in a third embodiment.

### DETAILED DESCRIPTION OF THE INVENTION

### First Exemplary Embodiment

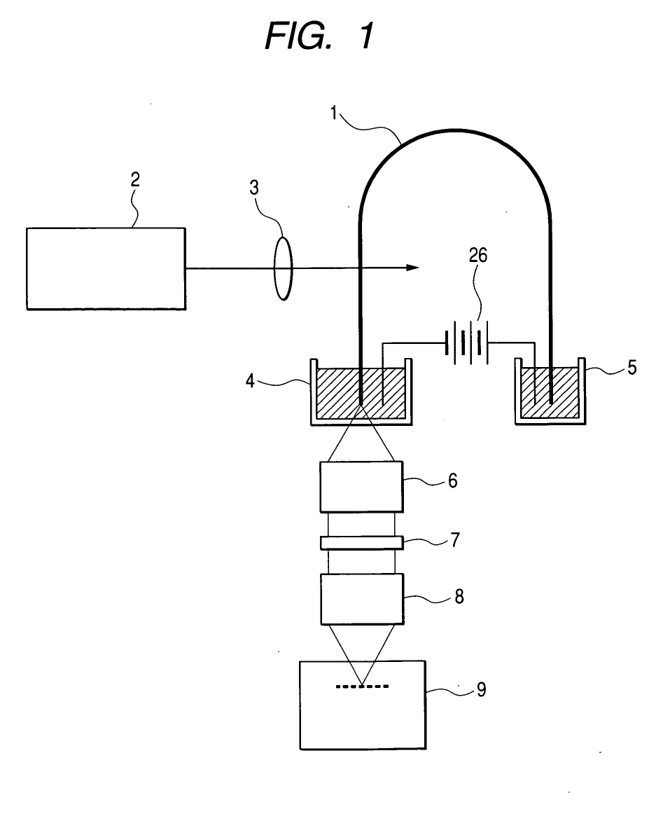

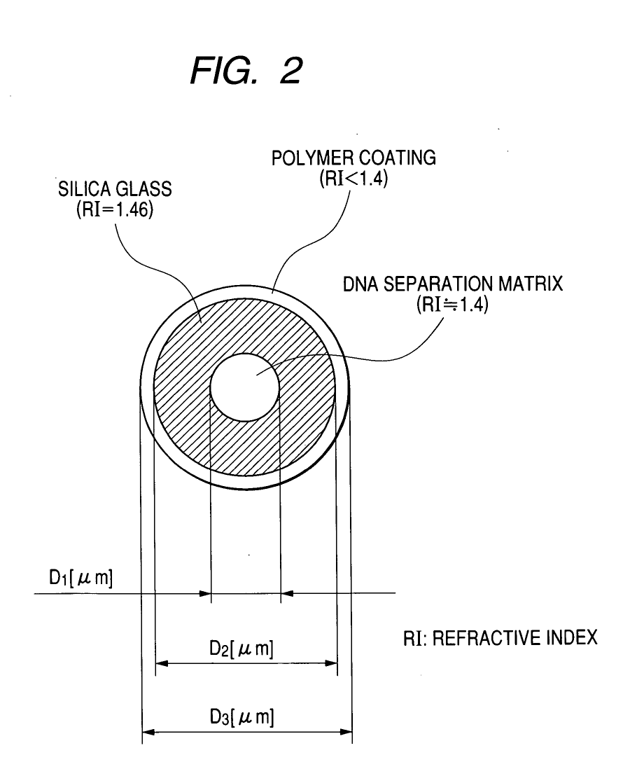

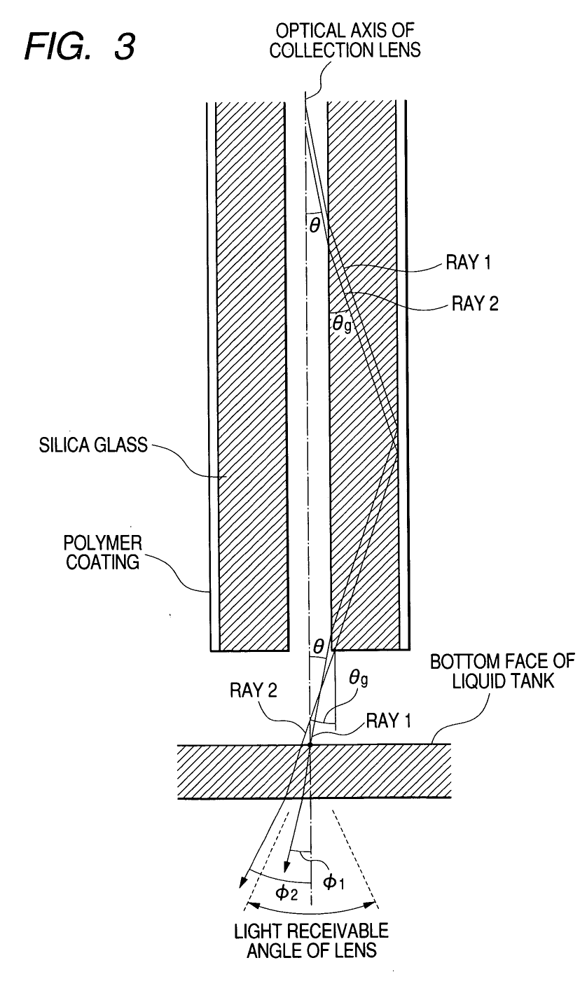

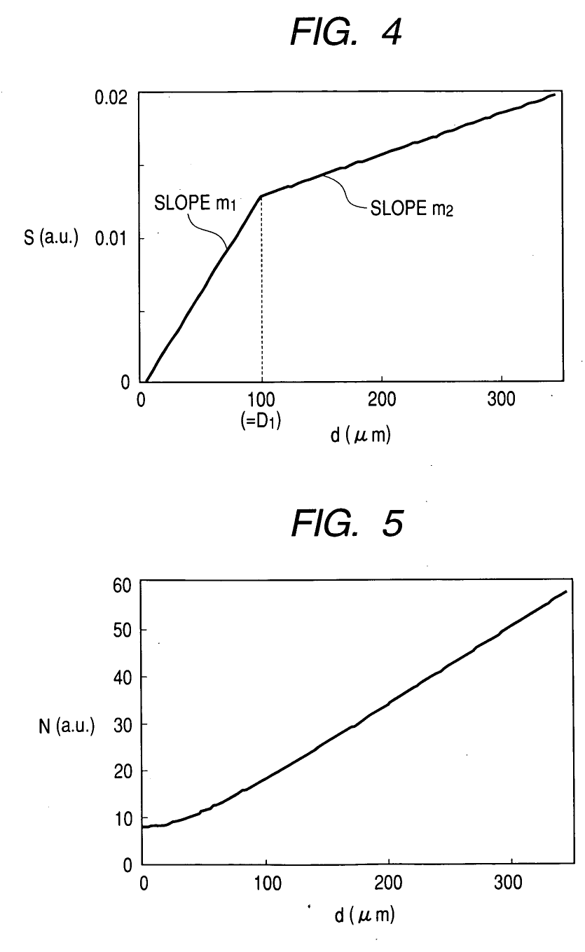

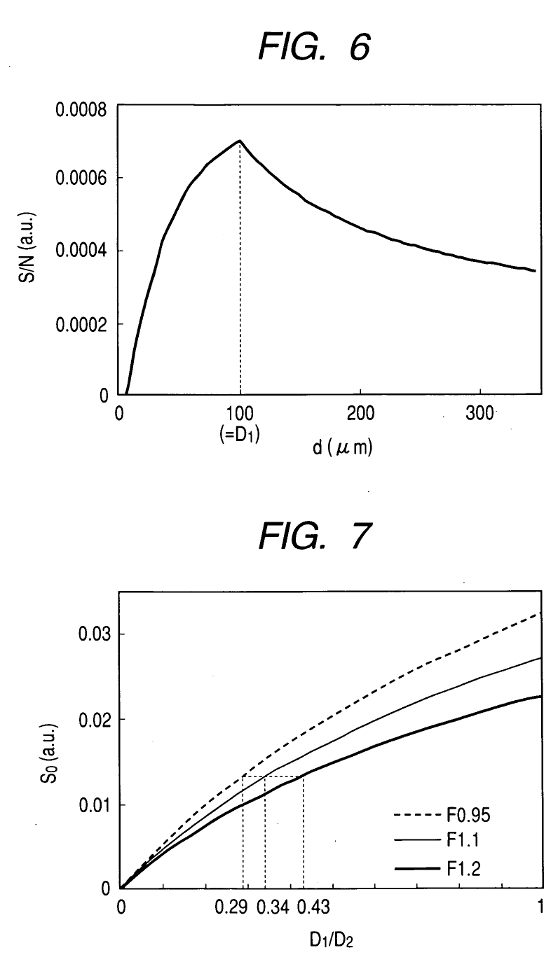

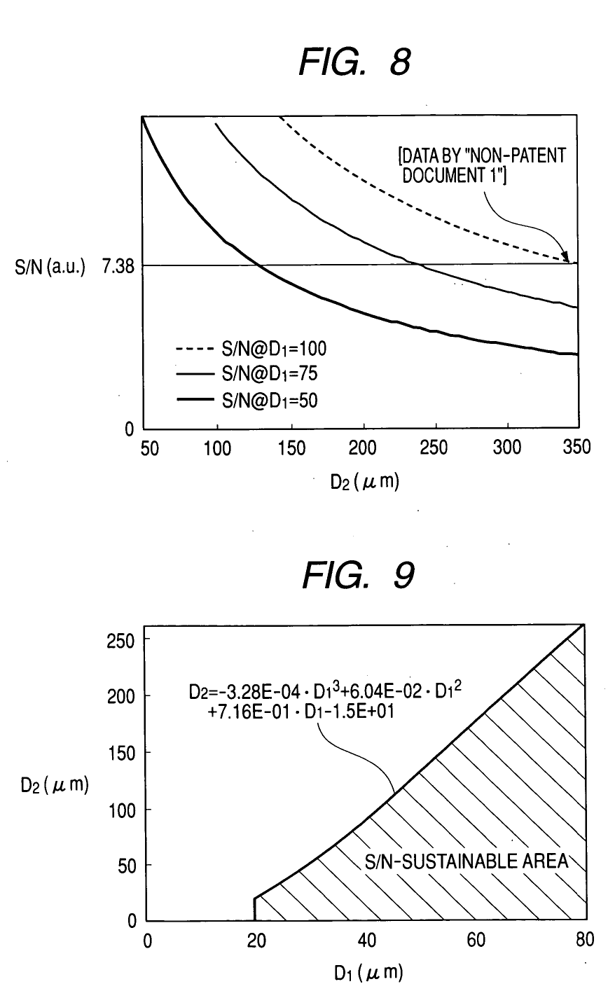

The basic composition of a first exemplary embodiment of the present invention is shown in FIG. 1. Using the term D₁ [μm] for the inner diameter of the capillary and D₂ [μm] for the glass outer diameter, the capillary of this embodiment satisfies the following two equations:
20≦D₁≦8 0 (7)
and
D₁/D₂≧0.34 (8)

Additionally, the glass surface of the capillary must be at least partially coated with a polymer whose refractive index is less than 1.4 (the refractive index of a separation matrix). The material of the coating in this embodiment is preferably colorless and transparent TEFLON™ AF1600 (Teflon is a registered trademark of DuPont) which has a refractive index n_{c}=1.31. As is apparent, a capillary coated with the Teflon™ AF2400 (also from DuPont) with a refractive index n_{c}=1.29 may also be used.

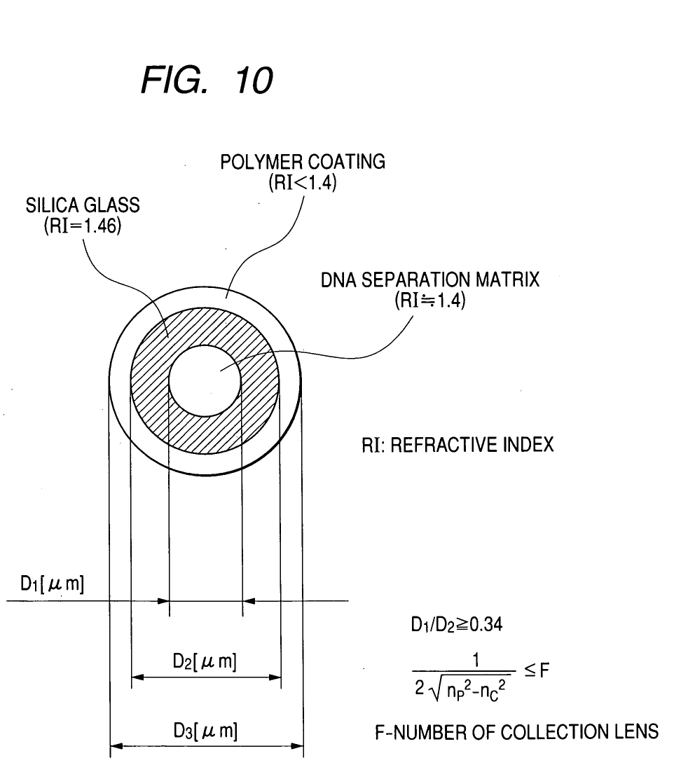

FIG. 10 shows a cross-section diagram of a capillary and the required specifications used in this embodiment. The thickness of the coating is not related to the performance of end detection. In order to retain the mechanical strength of the capillary, the coating thickness is preferably at least 10 μm, and more preferably at least 15 μm. In this embodiment, D₁=75, D₂=220, and D₃=250, and equations (7) and (8) are satisfied. As a result, both excellent electrophoretic performance and light collection efficiency can be obtained at the same time. Moreover, because the thickness of the coating is set to 15 μm, satisfactory strength is also obtained. In fact, any combination that satisfies equations (7) and (8) may be used as a pair of D₁ and D₂. For example, D₁ and D₂ may equal: 40 and 110; 50 and 130; and 60 and 175 within the scope fo this embodiment.

The outer diameter including a capillary coating allows 375 μm and 150 μm to be standardized and widely used. Even in Non-patent document 1, the capillary with an outer diameter of 375 μm is used. On the other hand, in end detection, the thickness of the coating is optional and not related to performance when the thickness is 10 μm or more. For example, when the coating thickness is 77.5 μm, a capillary of D₁=75, D₂=220, and D₃=375 may be used. Since this capillary has the same outermost diameter as that used in Non-patent document 1, the capillary can be mounted on the same electrophoresis system used in Non-patent document 1 without changing the design. In addition, light collection efficiency is sustained and electrophoretic performance improves as an effect.

In this first embodiment, a refractive index of a DNA separation index is set to nₚ=1.40, the refractive index of the coating of a capillary is set to n_{c}=1.31 or 1.29, and an f-number of a collection camera lens is set to F=1.1.

$$\frac{0.5}{\sqrt{{n}_{p}^{2} - {n}_{c}^{2}}} \leq F \qquad ( 9 )$$

Accordingly, equation (9) is satisfied, and the wasteful lens cost described above is not incurred.

### Second Exemplary Embodiment

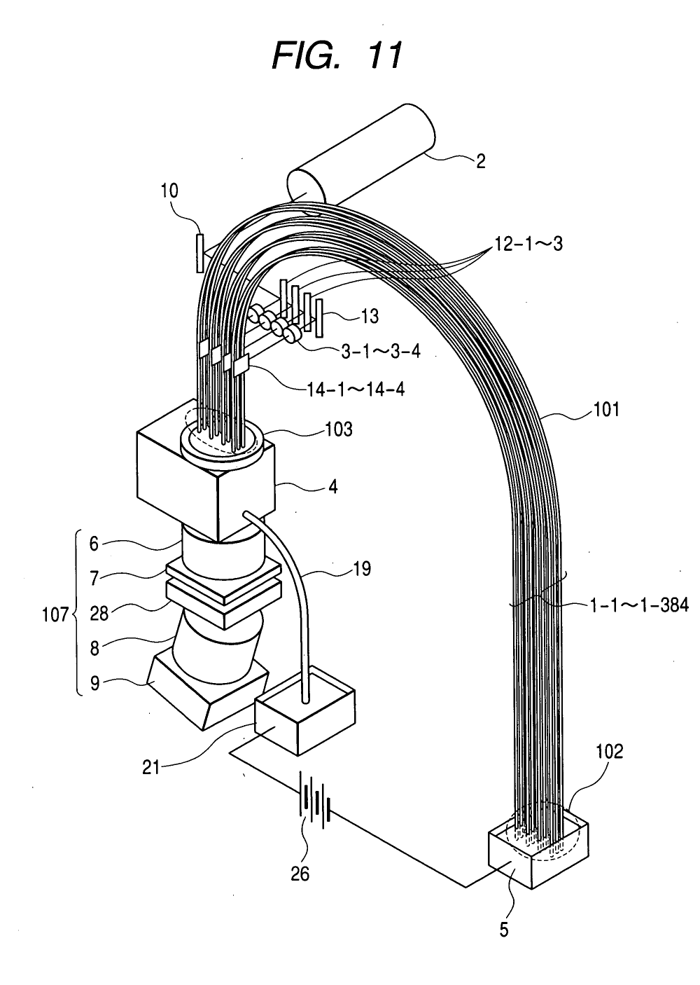

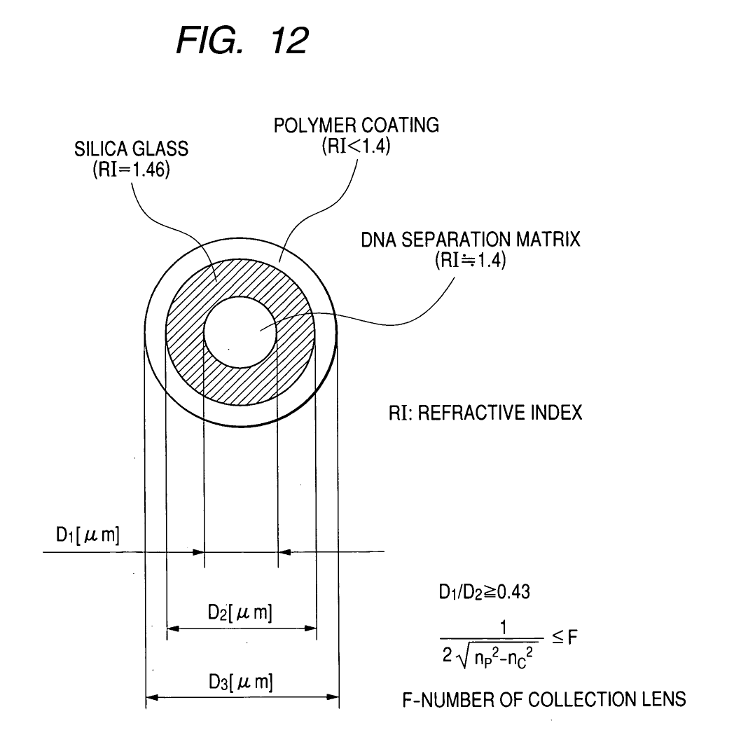

FIG. 11 shows the composition of a second exemplary embodiment of the present invention. In this embodiment, 384 capillaries are integrated, and a capillary array 101 is formed. Moreover, the total length of each of capillaries is approximately 40 cm. The side into which a sample is introduced, in each of the capillaries 1-1 to 1-384 is called a starting end 102, and the side on which the sample migrates inside the capillaries and is eluted by mean of electrophoresis is called a terminating end 103. The position separated 30 cm from the end face of the starting end 102 (separated 10 cm from the end face of the terminating end 103) of each capillary array 101 is referred to as a laser beam irradiation point, and the Teflon™ coating of the capillary in the portion is removed.

The laser beam irradiation points of 96 capillaries, on an average, 1-1 to 1-96, 1-93 to 1-192, 1-193 to 1-288, and 1-289 to 1-384 are arranged on four glass substrates 14-1 to 14-4, and four sets of capillary arrays are formed respectively. Each of the capillaries 1-1 to 1-384 is mutually aligned almost in parallel on each of the glass substrates 14-1 to 14-4. Each laser beam irradiation point is almost orthogonal to each of the capillaries 1-1 to 1-384, and is aligned in a straight line.

The laser beam (e.g., having the wavelengths of 488 nm and 515 nm, output of 100 mW) that is output from an argon ion laser light source 2 is divided into four by a mirror 10, beam splitters 12-1 to 12-3 and a mirror 13. The width of each of the split and reflected laser beams may be narrowed down by irradiation lens 3-1 to 3-4 (f=40 mm), and four sets of capillary arrays are irradiated with each laser beam from the side. Each laser beam is adjusted so as to become parallel to the glass substrates 14-1 to 14-4 and orthogonal to each of the capillaries 1-1 to 1-384 and the capillary arrays are irradiated with each laser beam.

In order to suppress the lowering of electrophoretic separation power, the laser beam width at which the capillary arrays are irradiated with each laser beam should preferably be set on the order of the capillary inner diameter (e.g., 50 μm) or below. The aforementioned laser beam irradiation is performed in a condition under which the inside of each of the capillaries 1-1 to 1-384 is filled with a DNA separation matrix (e.g., POP7™ manufactured by Applied Biosystems whose refractive index is 1.4). In this case, as described in Non-patent document 1, because the laser beam is transmitted in the capillary array, all capillaries can be irradiated with the laser beam efficiently at the same time.

The terminating end 103 of the capillary array 101 allows the 384 capillaries 1-1 to 1-384 to be bundled, the face of the terminating end 103 of each of the capillaries 1-1 to 1-384 to be arranged substantially in the same plane, which matches a detection plane to be formed. Each capillary detection-end face is aligned (two-dimensionally) on the detection plane in a grid shape of 96 multiplied by 4. At this point, the position in the starting end 102 of each of the capillaries 1-1 to 1-384 and the position in a capillary detection-end face correspond to each other.

The capillary array 101 is connected to a liquid tank 4. The liquid tank 4 is filled with the DNA separation matrix POP7™, and the capillary is thereby filled with the POP7™ from the liquid tank 4. The liquid tank 4 is made of acrylic resin, and a channel is formed inside. The inside is filled with a DNA separation matrix. A tube 19 is connected to a liquid tank 21 in which a buffer (e.g., 3700 Buffer manufactured by Applied Biosystems) is contained. In this embodiment, the POP7™ that is a non-cross-linked viscous fluid is used as the DNA separation matrix. However, even a capillary filled with a cross-linked gel whose refractive index is on the same degree may be used.

The fluorescence radiated from a capillary detection-end face is detected by a detection unit 107 having a collection lens 6 (F=1.2 and f=50), a filter 7, a prism 28, an imaging lens 8 (F=1.2 and f=50), and a two-dimensional CCD camera 9 (e.g., 512×512) from the lower direction of the liquid tank 4 through a channel filled with a DNA separation matrix, and the bottom face of the liquid tank 4 in which a detection window is fit.

In order to reduce fluorescence or scattered light from the material that the liquid tank 4 is made of (all except the fluorescence from a sample), the material of the detection window uses non-fluorescent silica glass. An optical filter that can remove the background light or excitation light may also be used as the detection window. Moreover, the entirety of the liquid tank 4 is preferably made of a non-fluorescent and transparent material, and the detection window can also be integrated with the liquid tank 4. In this embodiment, the distance from the detection plane to the outer surface of the detection window is set to 20 mm, and is made shorter than the focal length of 50 mm of the collection lens 6.

The capillary starting end 102 is impregnated in a buffer, and a voltage is applied between a buffer tank 21 and the liquid tank 5 by a high-voltage power supply 506. Thereafter, the sample radiated into each of the capillaries 1-1 to 1-384 migrates electrophoretically in the direction of the terminating end 103. At this time, a difference of the altitude of a liquid level between the buffer contained in the buffer liquid tank 21 and the buffer contained in the liquid tank 5 is removed so that the DNA separation matrix in each of the capillaries 1-1 to 1-384 cannot move due to a pressure difference.

A sample that migrates electrophoretically in each of the capillaries 1-1 to 1-384 is irradiated with a laser beam in the laser beam irradiation point of each of the capillaries. A phosphor that is labeled on the sample is excited by means of laser beam irradiation. A portion of the fluorescence is completely reflected on the inner surface of each of the capillaries 1-1 to 1-384 and propagates inside each of the capillaries. Then, the fluorescence is radiated from the detection-end face of each of the capillaries 1-1 to 1-384. The radiated fluorescence changes into a collimated beam through the detection window of the liquid tank 4 by the collection lens 6. Background light and excitation light are removed from the fluorescence by the filter 7, and the fluorescence is dispersed with respect to a wavelength by a prism 28.

An image is then formed on the two-dimensional CCD camera 9 by the imaging lens 8. Moreover, an object lens can also be used instead of the collection lens 6. The distance between the collection lens 6 and a capillary detection-end face is set to 50 mm. The image in which the fluorescence from each of the capillaries 1-1 to 1-384 is dispersed with respect to the wavelength is focused at a different position of the two-dimensional CCD camera 9. Accordingly, the fluorescence from each of the capillaries 1-1 to 1-384 can be detected independently and collectively. Moreover, a change with time in the fluorescence from each of the capillaries 1-1 to 1-384 is measured by continuously repeating this detection. Multiple types of samples can be analyzed by recording an obtained measurement result in a computer and analyzing the result.

If external stray light enters the detection unit 107 when fluorescence is detected, this may result in the lowering of the detection sensitivity of the fluorescence that is radiated from a capillary detection-end face. Accordingly, the areas of the liquid tank 4 and the detection unit 107 should preferably be shielded externally from the laser beam irradiation points of each of the capillaries 1-1 to 1-384. In this embodiment, the aforementioned entirety of the areas is covered with a black box. The entirety of the areas is divided into the aforementioned three areas, and the three areas can also be covered with the black box. Moreover, the material of the liquid tank 4 uses black acrylic resin or black plastic, with which the external stray light can further be shielded.

FIG. 12 shows a cross-section diagram of the capillaries 1-1 to 1-384 and a required specification. The specification required for the capillaries that are used in this embodiment is almost the same as that specified for the first exemplary embodiment. However, because a lens of F=1.2 is used, equation (10):
D₁/D₂≧0.43 (10)
must be satisfied. In this exemplary embodiment, F=1.2, but equation (10) must be satisfied even if F=1.4 or F=1.8, in other examples. In this embodiment, equation (10) is satisfied by specifying D₁=50, D₂=100, and D₃=130. Any combination that satisfies equation (6) and equation (10) may be used as a pair of D₁ and D₂. For example, D₁ and D₂ may equal: 40 and 85; 60 and 130; and 75 and 165.

In this embodiment, because nₚ=1.4, n_{c}=1.31, and F=1.2, equation (6) is satisfied, and the wasteful lens cost described above is not incurred in the same manner as the first embodiment.

In this second exemplary embodiment, stable DNA sequencing is enabled by specifying the inner diameter as half that for Non-patent document 1 using a high electric field of at least three times (e.g., 320 V/cm). In this embodiment, the 384 capillaries of at least four times those of Non-patent document 1 are integrated, and a simultaneous analysis of 384 samples is enabled.

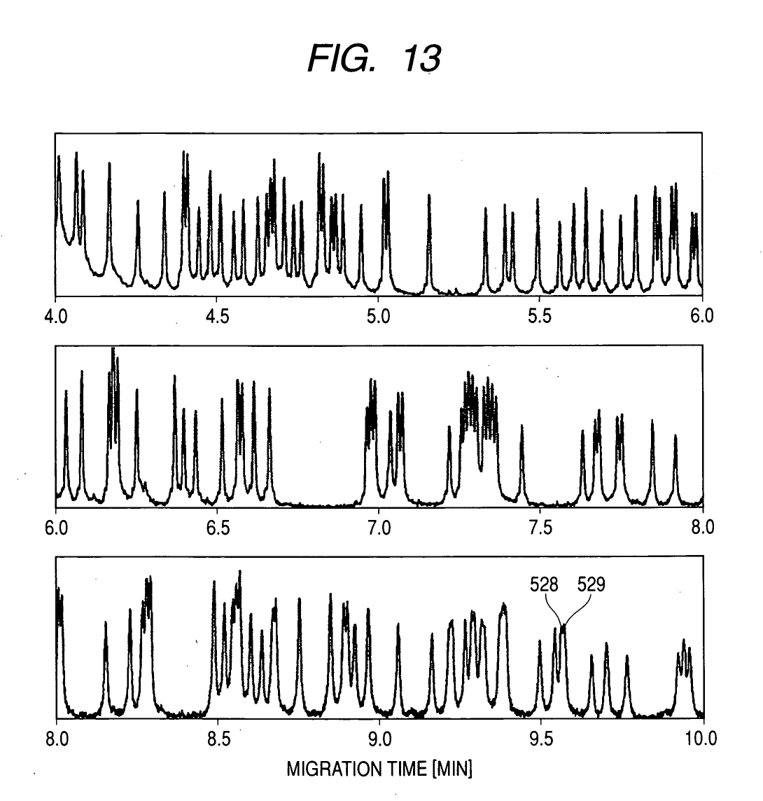

FIG. 13 shows a sequence electropherogram obtained from a typical capillary 1-357. The sample is a monochromatic sequencing reaction product labeled by an ROX primer in which an M13 mp 18 is used as a template. Single base resolution up to 529 bases is attained within ten minutes. That is, about 500 bases can be read within ten minutes. Moreover, the mean migration time of 154 bases is six minutes, and a faster analysis of at least six times that of Non-patent document 1 is realized. These types of performance are equaled in the other 383 capillaries. Accordingly, the throughput of a total of 25 times that of Non-patent document 1 is realized maintaining the same light collection efficiency.

In this embodiment, 96 capillaries multiplied by four columns are evenly arranged in both a laser beam irradiation unit and a detection unit. However, other arrangements, for example, 128 capillaries multiplied by three columns and 192 capillaries multiplied by two columns are also possible. Accordingly, both the laser beam irradiation unit and the detection unit can also adopt an individual arrangement. For example, when the laser beam irradiation unit adopts the 128 capillaries multiplied by three columns and the detection unit adopts the 96 capillaries multiplied by four columns, the laser beam irradiation efficiency improves and the width of a detection plane is not changed. Accordingly, a bright collection lens of F=1.2 can be used, and higher sensitivity may be obtained.

In this embodiment, fluorescence is detected from the terminating end 103 through the liquid tank 4, but the fluorescence can also be detected from the starting end 102 through the liquid tank 5.

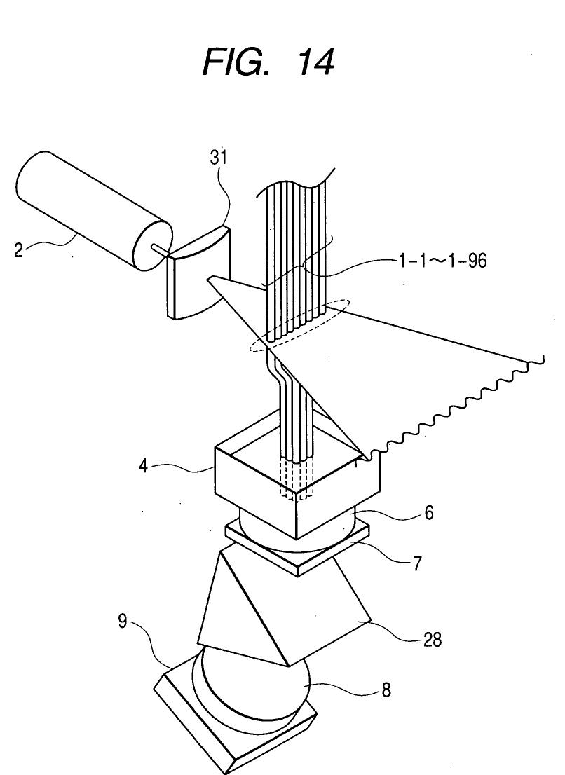

In this embodiment, a plane on which a capillary is aligned is irradiated with a laser beam in parallel to the plane. However, as shown in FIG. 14, the capillaries 1-1 to 1-96 can also be irradiated with the laser beam by widening the laser beam by a cylindrical lens 31. In this case, because the capillary need not be arranged accurately in an irradiation unit, a capillary array can be manufactured inexpensively as an effect. The same effect is also obtained by scanning the laser beam in the direction in which the capillary is aligned. When the capillary is aligned in one column at a detection end, a diffraction grating can also be used instead of a prism.

### Third Exemplary Embodiment

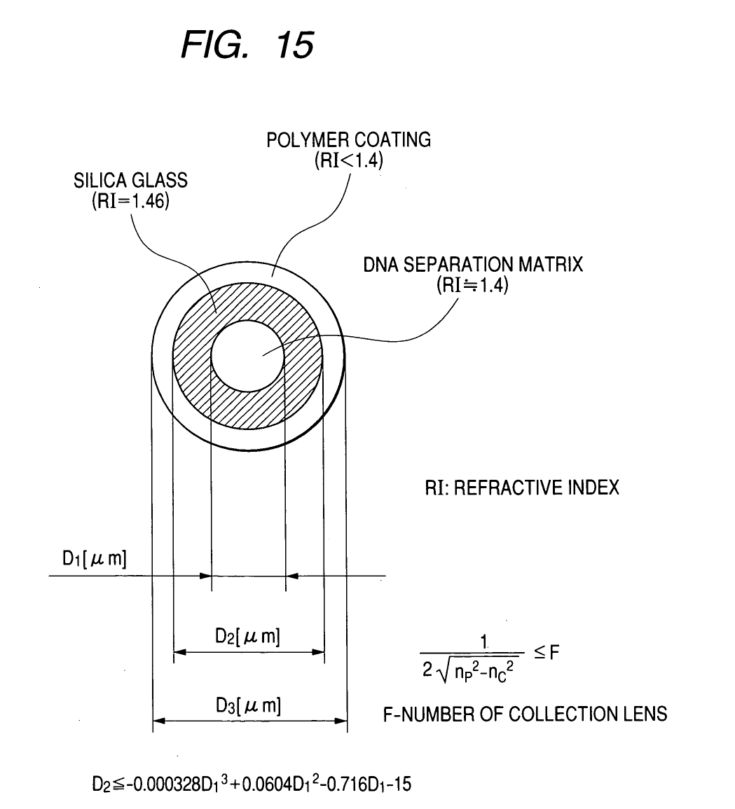

FIG. 15 shows a cross-section diagram of a capillary and a required specification for a third exemplary embodiment of the present invention. The composition of the capillary electrophoresis apparatus in this embodiment is the same as for the first or second embodiments. The capillary inner bore is filled with a DNA separation matrix whose refractive index is about RI=1.4. In this embodiment, assuming the capillary inner diameter is D₁ [μm] and the glass outer diameter is D₂ [μm], equations (11) and (12):
20≦D₁≦30 (11)
and
D₂≦−0.000328D₁³+0.0604D₁²+0.716D₁−15 (12)
are satisfied, and the glass surface of the capillary is coated with a polymer whose refractive index is less than 1.4. The material of the coating in this embodiment is preferably colorless and transparent Teflon™ AF1600 (DuPont) with a refractive index n_{c}=1.31. A capillary coated with Teflon™ AF2400 (also from DuPont) with a refractive index n_{c}=1.29 can also be used in this embodiment.

The thickness of the coating is not related to the performance of end detection. In order to sustain the mechanical strength of the capillary, the coating thickness is preferably at least 10 μm and more preferably at least 15 μm. In this embodiment, D₁=50, D₂=120, and D₃=150 to satisfy these conditions. Any combination that satisfies equation (11) and equation (12) can be used as a pair of D₁ and D₂. For example, D_{1 and D}₂ may equal: 40 and 85; 60 and 160; and 75 and 200. Since this type of capillary is used, the same S/N as that of Non-patent document 1 is maintained, and stable electrophoretic separation is obtained in less than half time.

In this embodiment, nₚ=1.4, n_{c}=1.31, and F=1.2, that is, for example, F=1.4. Accordingly, equation (6) is satisfied, and a needless lens cost (described above) does not occur in the same manner as described with respect to the first embodiment.

### Fourth Exemplary Embodiment

In this embodiment, the composition of the capillary electrophoresis apparatus is the same as for the first or the second embodiment. The capillary inner diameter is filled with a DNA separation matrix whose refractive index is about RI=1.4, and the glass surface of the capillary is coated with a polymer whose refractive index is less than 1.4. As an electrophoresis capillary, the capillary whose inner diameter is 75, 50, or 40 μm is standardized. If the inner diameter is identical even when the outer diameter or the coating of the capillary varies, mostly common electrophoretic conditions can be applied as an advantage.

Accordingly, in a fourth embodiment, the inner diameter is fixed at 75, 50, or 40 μm, and a capillary that satisfies the fourth embodiment is used. In production, the capillary inner diameter cannot prevent an error of ±3 μm. Assuming the capillary inner diameter is D₁ [μm] and the glass outer diameter is D₂ [μm], the ranges of D₁ that correspond to the nominal diameter of 75, 50 or 40 μm are 75±3, 50±3 and 40±3. The ranges of D₂ that satisfy D₁/D₂≧0.34 in regard to the D₁ of these ranges are D₂≦229, D₂≦156 and D₂≦126. Accordingly, the specification with which the capillary should be satisfied in this embodiment is defined according to the following equations:
(D₁=75±3 and D₂≦229) or
(D₁=50±3 and D₂≦156) or
(D₁=40±3 and D₂≦126).

A unique effect by which the electrophoretic conditions optimized by a conventional CE system can be easily implanted is obtained. Moreover, in this embodiment, nₚ=1.4, n_{c}=1.31, and F≧1.2, that is, for example, F=1.4. Accordingly, equation (6) is satisfied, and a needless lens cost (as described above) does not occur in the same manner as the first embodiment. The embodiments of the present invention described above, therefore, can be utilized for an extremely high throughput DNA sequencer.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

1. A capillary electrophoresis apparatus, comprising:
a cylindrical glass capillary having an inner diameter D₁ [μm] filled with a separation matrix, a glass outer diameter D₂ [μm], and a terminating end, in which a sample is separated electrophoretically inside said separation matrix;
a liquid tank provided on the terminating end of said capillary; and
a detector that detects fluorescence emitted from an analyte of said sample, wherein 20≦D₁≦80 and D₁/D₂≧0.34.

2. A capillary electrophoresis apparatus according to claim 1, further comprising:
a lens that collects said fluorescence provided between said liquid tank and said detector, an f-number of said lens being at least 1.0.

3. A capillary electrophoresis apparatus according to claim 1, further comprising:
a lens that collects said fluorescence provided between said liquid tank and said detector, an f-number of said lens being at least 1.2 and D₁/D₂≧0.43.

4. A capillary electrophoresis apparatus according to claim 1, wherein a refractive index of said separation matrix is at least 1.36 and is less than 1.42.

5. A capillary electrophoresis apparatus according to claim 1, further comprising:
a lens that collects said fluorescence provided between said liquid tank and said detector, wherein at least part of an outer surface of said glass capillary is coated with a polymer, further wherein 0.5/(nₚ²−n_{c}²)^{0.5}≦F where the refractive index of said polymer is n_{c}, the refractive index of said separation matrix is nₚ, and the f-number of said lens is F.

6. A capillary electrophoresis apparatus according to claim 5, wherein nₚ is at least 1.36 and is less than 1.42.

7. A capillary electrophoresis apparatus according to claim 5, wherein the thickness of said polymer coating is at least 10 μm.

8. A capillary electrophoresis apparatus according to claim 5, wherein the refractive index of said polymer is lower than the refractive index of said separation matrix.

9. A capillary electrophoresis apparatus according to claim 1, wherein said capillary is a plurality of capillaries each of which includes a terminating end, and said terminating ends are arranged in a two-dimensional matrix.

10. A capillary electrophoresis apparatus according to claim 1, further comprising:
a laser beam light source, wherein said capillary is a plurality of capillary arrays, further wherein said laser beam is provided from the side through each of said capillary arrays.

11. A capillary electrophoresis apparatus according to claim 1, further comprising:
a laser beam light source; and
a beam lens, wherein said capillary is a plurality of capillaries, and further wherein said light source irradiates said plurality of capillaries with said laser beam through said beam lens that widens said laser beam in the direction in which said capillaries are aligned between said light source and said capillaries.

12. A capillary electrophoresis apparatus, comprising:
a cylindrical glass capillary having an inner diameter D₁ [μm] filled with a separation matrix and a glass outer diameter D₂ [μm], in which a sample is separated electrophoretically inside said separation matrix; and
a detector that detects fluorescence emitted from a component of said sample from a direction in which said capillary is extended, wherein 20≦D₁≦80 and D₂≦−0.00328D₁³+0.0604D₁²+0.716D₁−15.

13. A capillary electrophoresis apparatus according to claim 12, wherein the refractive index of said separation matrix is at least 1.36 and less than 1.42.

14. A capillary electrophoresis apparatus according to claim 12, further comprising:
a laser beam light source, wherein said capillary is a plurality of capillary arrays, further wherein said laser beam is provided from the side through each of said capillary arrays.

15. A capillary electrophoresis apparatus, comprising:
a cylindrical glass capillary having an inner diameter D₁ [μm] filled with a separation matrix, a glass outer diameter D₂ [μm], and a terminating end, in which a sample is separated electrophoretically inside said separation matrix;
a liquid tank provided on the terminating end of said capillary; and
a detector that detects fluorescence emitted from an analyte of said sample, wherein (D₁=75±3 and D₂≦229) or (D₁=50±3 and D₂≦156) or (D₁=40±3 and D₂≦126).

16. A capillary electrophoresis apparatus according to claim 15, further comprising:
a lens that collects said fluorescence provided between said liquid tank and said detector, an f-number of said lens being at least 1.0.

17. A capillary for electrophoresis, comprising:
a cylindrical glass capillary having an inner diameter D₁ [μm] and a glass outer diameter D₂ [μm], wherein 20≦D₁≦80 and D₁/D₂≧0.34.

18. A capillary according to claim 17, wherein dimensions of said capillary satisfies (D₁=75±3 and D₂≦229) or (D₁=50±3 and D₂≦156) or (D₁=40±3 and D₂≦126).

19. A capillary according to claim 17, further comprising:
at least one additional capillary, wherein said capillaries are formed in an array.
